(19) United States
(12) Patent Application Publication
(10) Pub. No.: US 2010/0309847 A1
(43) Pub. Date: Dec. 9, 2010

(54) METHOD AND APPARATUS FOR IMS APPLICATION DOMAIN SELECTION AND MOBILITY

(75) Inventor: Murali B. Bharadwaj, San Diego, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/755,613

(22) Filed: Apr. 7, 2010

Related U.S. Application Data
(60) Provisional application No. 61/184,046, filed on Jun. 4, 2009.

(51) Int. Cl. H04W 40/00

(52) U.S. Cl. 370/328

(57) ABSTRACT

A method, an apparatus, and a computer program product for wireless communication are provided in which a multimode access terminal, capable of accessing IMS services through a plurality of wireless domains, includes a domain selector for selecting among the plurality of domains based on selection criteria such as RF signal quality, QoS, and pre-configured policies stored in memory.

### CROSS-REFERENCE TO RELATED APPLICATION(S)

Pursuant to 35 U.S.C. §119(e), this application claims the benefit of U.S. Provisional Application Ser. No. 61/184,046 filed on Jun. 4, 2009, the contents of which are hereby incorporated by reference herein in their entirety.

### BACKGROUND

1. Field

The present disclosure relates generally to communication systems, and more particularly, to wireless access of IP multimedia subsystem (IMS) services.

2. Background

Wired and wireless communication systems are widely deployed to provide various telecommunication services such as telephony, video, data, messaging, and broadcasts. Many advanced communication systems utilize an IP Multimedia Subsystem (IMS) architecture to integrate these services and thus improve user experience.

IMS refers to an industry-wide standard originally implemented by 3GPP (see 3GPP TS 23.228) and later adopted by 3GPP2 (see 3GPP2 X.50013). Substantial interest and developmental effort has been directed toward IMS, and many carriers are now deploying IMS in their networks. Further, 3GPP views IMS-based VoIP as the best solution for voice services in next-generation LTE networks.

In summary, IMS is a distributed network architecture for enhanced delivery of multimedia services. IMS utilizes the Internet protocol (IP) to enable the sending of voice, data, and video between communication devices on IP addressable data networks. That is, support for applications utilizing voice, videoconferencing, push-to-talk, instant messaging, or other multimedia services that utilize varied data rates, latencies, QoS, etc., may be integrated onto the same network. Further, IMS may apply to essentially all types of wired and wireless networks or domains, including but not limited to UMTS, HSPA, HSPA+, 3GPP LTE, LTE Advanced, CDMA2000, EV-DO, Wireless LAN (IEEE 802.11), WiMAX (IEEE 802.16), etc.

To utilize an IMS network, an access terminal generally obtains a registration with a proxy server (i.e., a SIP server) on the IMS network by utilizing a particular domain. However, within the currently released IMS standards, a particular multimode mobile device may only obtain a single registration at a time. In other words, multimode user equipment (UE), which is capable of communicating over a plurality of domains, may only utilize the IMS registration over a single domain, such as a cellular network, at a particular time. Because the standard does not currently provide for multiple registrations on multiple domains, if multiple applications are run concurrently on a UE, they must share a particular domain, and at least one of the applications may be required to compromise in terms of its desired QoS, data rate, etc. Thus, there is room in the art for improvements in the selection of domains.

### SUMMARY

The following presents a simplified summary of one or more aspects of this disclosure in order to provide a basic understanding of such aspects. This summary is not an extensive overview of all contemplated aspects of the disclosure, and is intended to neither identify key or critical elements of all aspects nor delineate the scope of any or all aspects. Its sole purpose is to present some concepts of one or more aspects of the disclosure in a simplified form as a prelude to the more detailed description that is presented later.

In an aspect of the disclosure, a method, an apparatus, a computer program product, and a processing system for wireless communication are provided in which a multimode access terminal, capable of obtaining an IMS registration through at least a first domain and a second domain, includes selecting the first domain or the second domain for an IMS communication session in accordance with at least one selection criterion. Here, the selection criterion may include RF signal quality, QoS, and/or operator pre-configured policies.

In another aspect of the disclosure, a processing system for use in a multimode access terminal capable of obtaining an IMS registration through at least a first domain and a second domain includes a memory module for storing domain policies, an RF measurement module for retrieving RF signal information associated with the first domain and the second domain, a QoS manager for retrieving QoS information associated with the first domain and the second domain, and a domain selector for selecting one of the first domain or the second domain in response to the RF signal information, the QoS information, and the domain policies.

These and other aspects of the disclosure will be better understood upon a review of the detailed description, which follows.

### BRIEF DESCRIPTION OF THE DRAWINGS

FIG. 1 is a conceptual diagram illustrating an example of a hardware implementation for an apparatus employing a processing system.

FIG. 2 is a conceptual diagram illustrating an example of a network architecture.

FIG. 3 is a conceptual diagram illustrating an example of an access network.

FIG. 4 is a conceptual block diagram of a multi-domain wireless communications system including a cellular network and a WLAN.

FIG. 5 is a conceptual diagram illustrating an example of a base station and UE in an access network.

FIG. 6 is a conceptual block diagram illustrating certain modules within a UE

FIG. 7 is a flow chart of a process of initiating a new call according to an aspect of the disclosure.

FIG. 8 is a flow chart illustrating a process of monitoring and maintaining an ongoing IMS communication session on one or more domains.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawing by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. A computer-readable medium may include, by way of example, a magnetic storage device (e.g., hard disk, floppy disk, magnetic strip), an optical disk (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, a carrier wave, a transmission line, and any other suitable medium for storing or transmitting software. The computer-readable medium may be resident in the processing system, external to the processing system, or distributed across multiple entities including the processing system. Computer-readable medium may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

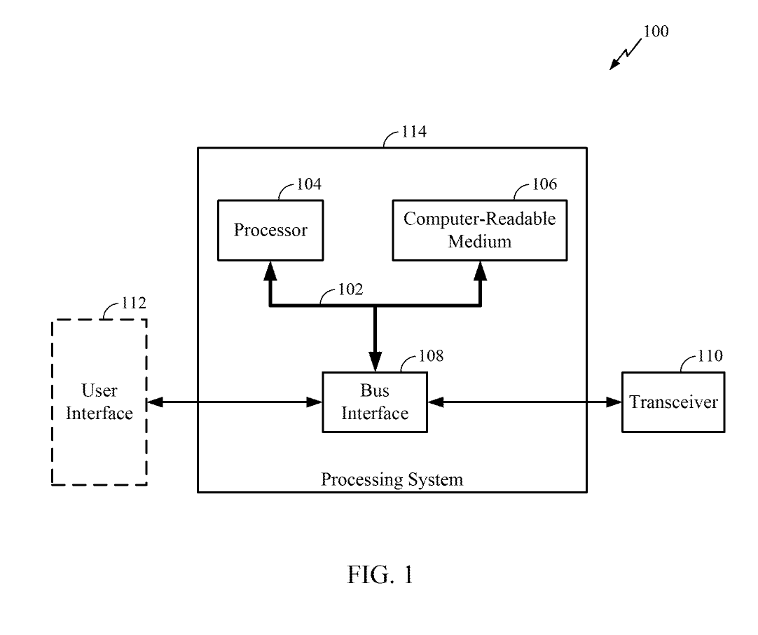

FIG. 1 is a conceptual diagram illustrating an example of a hardware implementation for an apparatus 100 employing a processing system 114. In this example, the processing system 114 may be implemented with a bus architecture, represented generally by the bus 102. The bus 102 may include any number of interconnecting buses and bridges depending on the specific application of the processing system 114 and the overall design constraints. The bus 102 links together various circuits including one or more processors, represented generally by the processor 104, and computer-readable media, represented generally by the computer-readable medium 106. The bus 102 may also link various other circuits such as timing sources, peripherals, voltage regulators, and power management circuits, which are well known in the art, and therefore, will not be described any further. A bus interface 108 provides an interface between the bus 102 and a transceiver 110. The transceiver 110 enables communication with various other apparatus over a transmission medium. Depending upon the nature of the apparatus, a user interface 112 (e.g., keypad, display, speaker, microphone, joystick) may also be provided.

The processor 104 is responsible for managing the bus 102 and general processing, including the execution of software stored on the computer-readable medium 106. The software, when executed by the processor 104, causes the processing system 114 to perform the various functions described infra for any particular apparatus. The computer-readable medium 106 may also be used for storing data that is manipulated by the processor 104 when executing software.

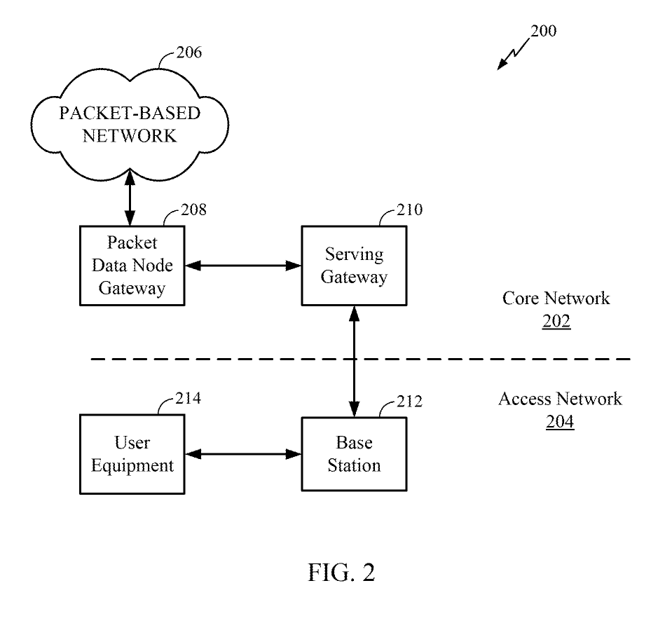

An example of a telecommunications system employing various apparatus will now be presented with reference to a cellular network architecture as shown in FIG. 2. The cellular network architecture 200 is shown with a core network 202 and an access network 204. In this example, the core network 202 provides packet-switched services to the access network 204, however, as those skilled in the art will readily appreciate, the various concepts presented throughout this disclosure may be extended to core networks providing circuit-switched services.

The access network 204 is shown with a single apparatus 212, which is commonly referred to as a base station, but may also be referred to by those skilled in the art as a base transceiver station, a radio base station, a radio transceiver, a transceiver function, a basic service set (BSS), an extended service set (ESS), a NodeB, an eNodeB, or some other suitable terminology. The base station 212 provides an access point to the core network 202 for a mobile apparatus 214. Examples of a mobile apparatus include a cellular phone, a smart phone, a session initiation protocol (SIP) phone, a laptop or netbook, a personal digital assistant (PDA), a satellite radio, a global positioning system, a multimedia device, a video device, a digital audio player (e.g., MP3 player), a camera, a game console, or any other similar functioning device. The mobile apparatus 214 is commonly referred to as user equipment (UE), but may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The core network 202 is shown with several apparatus including a packet data node (PDN) gateway 208 and a serving gateway 210. The PDN gateway 208 provides a connection for the access network 204 to a packet-based network 206. In this example, the packet-based network 206 is the Internet, but the concepts presented throughout this disclosure are not limited to Internet applications. The primary function of the PDN gateway 208 is to provide the UE 214 with network connectivity. Data packets are transferred between the PDN gateway 208 and the UE 214 through the serving gateway 210, which serves as the local mobility anchor as the UE 214 roams through the access network 204.

An example of typical usage scenario will now be presented with reference to

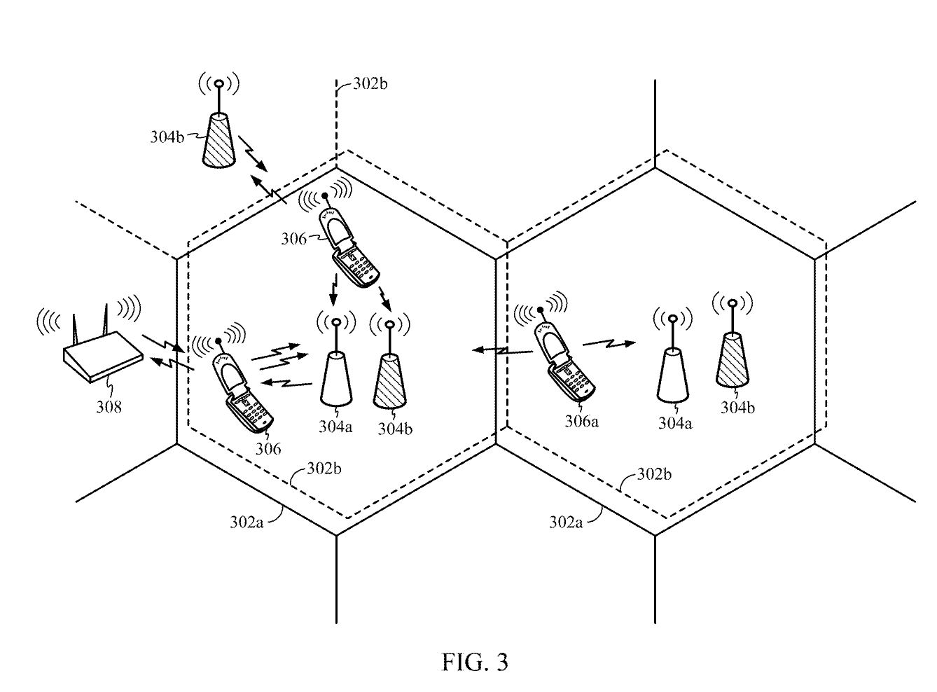

FIG. 3. In this example, a multimode UE 306 is in communication with one or more of cellular base stations 304a, 304b and/or wireless router 308. Although not illustrated, the UE 306 may be alternately or additionally in communication with a wired interface to the network or one or more additional wireless air interfaces.

Referring to FIG. 3, a first domain utilizes a first access network, divided into a number of first cellular regions (cells) 302a, and a second domain utilizes a second access network, divided into a number of second cells 302b. A first base station 304a is assigned to a first cell 302a, and a second base station 304b is assigned to a second cell 302b, each base station 304a, 304b being configured to provide an access point to a respective core network 202 (see FIG. 2) for all the UEs 306 in the respective cell 302a, 302b.

There is no centralized controller illustrated in this example, but a centralized controller may be used in alternative configurations. The base station 304a, 304b may be responsible for all radio related functions within the respective cell including radio bearer control, admission control, mobility control, scheduling, security, and connectivity to the serving gateway 210 in the respective core network 202 (see FIG. 2). As an example, the first access network may be a UMTS terrestrial radio access network (UTRAN), and the second access network may be an evolution-data optimized (EV-DO) air interface operating on a CDMA2000 network. Of course, alternate configurations may include a 3GPP LTE network or any other cellular telecommunications network utilizing IMS.

A local area network (LAN) may also be available to the UE 306 by way of an air interface with wireless router 308. In one example, wireless router 308 may be a home router communicating over an IEEE 802.11n air interface, although any suitable air interface for a LAN may be used in its place.

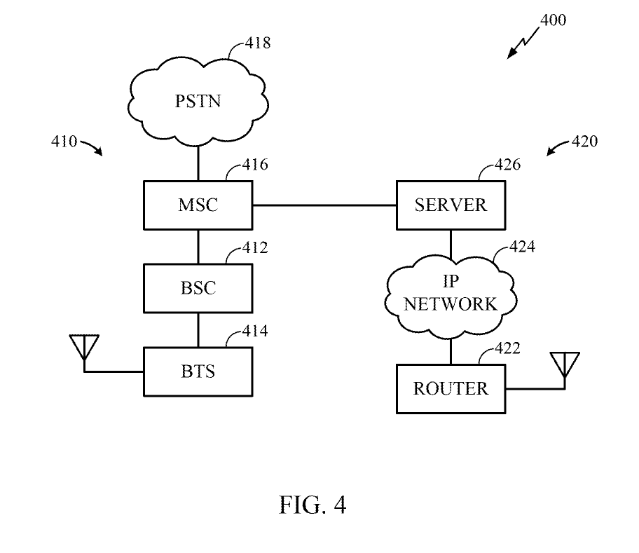

FIG. 4 is a conceptual block diagram of a multi-domain wireless communications system 400 including a cellular network and a WLAN, according to an aspect of the disclosure. The cellular network 410 (e.g., a first domain) includes a base station controller (BSC) 412 supporting a number of base transceiver stations (BTSs) dispersed throughout the cellular coverage region. A single BTS 414 is shown in FIG. 4 for simplicity of explanation. A mobile switching center (MSC) 416 may be used to provide a gateway to a public switched telephone network (PSTN) 418. Although not shown in FIG. 4, the cellular network 410 may employ numerous BSCs each supporting any number of BTSs to extend the geographic reach of the cellular network 410. When multiple BSCs are employed throughout the cellular network 410, the MSC 416 may also be used to coordinate communications between the BSCs.

The wireless communication system 400 may also include one or more wireless LANs 420 (i.e., a second domain) dispersed throughout the cellular coverage region. A single wireless LAN 420 is shown in FIG. 4. The wireless LAN 420 may be an IEEE 802.11 network, or any other suitable network. The wireless LAN 420 includes a router or an access point 422 for the UE to communicate with an IP network 424. A server 426 may be used to interface the IP network 424 to the MSC 416, which provides a gateway to the PSTN 418.

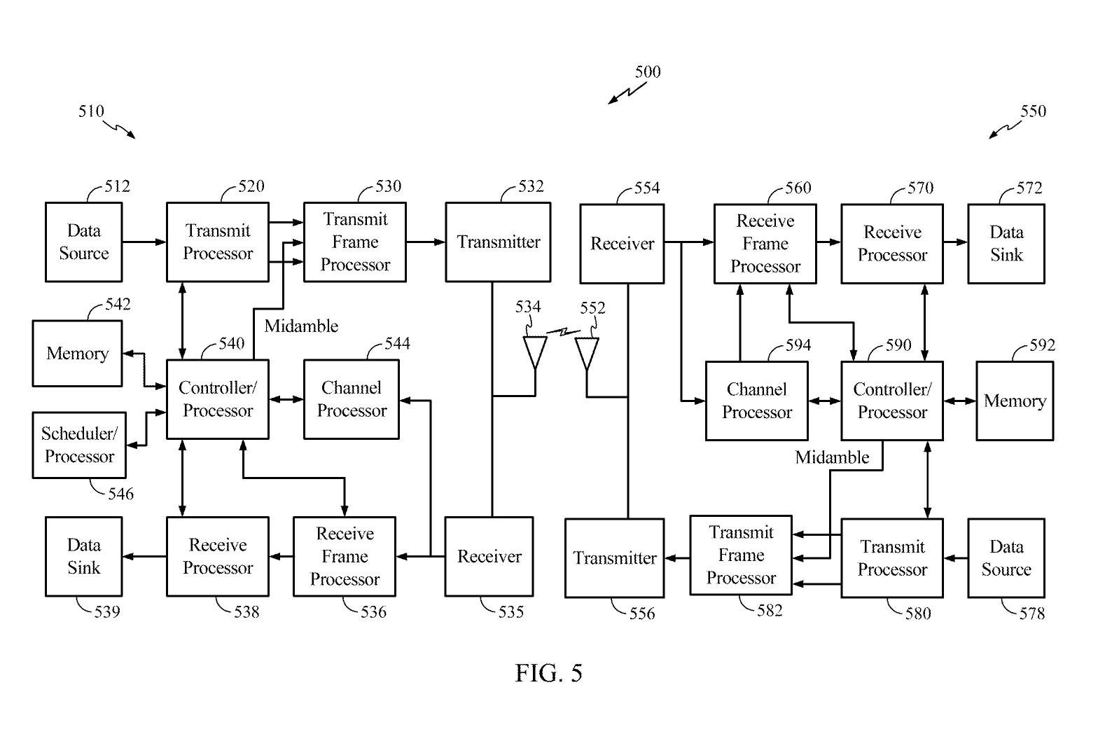

FIG. 5 is a block diagram of a node B 510 in communication with a UE 550 in a RAN 500, where the RAN 500 may be the access network 204 in FIG. 2, the node B 510 may be the base station 212 in FIG. 2, and the UE 550 may be the UE 214 in FIG. 2. In the downlink communication, a transmit processor 520 may receive data from a data source 512 and control signals from a controller/processor 540. The transmit processor 520 provides various signal processing functions for the data and control signals, as well as reference signals (e.g., pilot signals). For example, the transmit processor 520 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 544 may be used by a controller/processor 540 to determine the coding, modulation, spreading, and/or scrambling schemes for the transmit processor 520. These channel estimates may be derived from a reference signal transmitted by the UE 550 or from feedback contained in the midamble 214 (FIG. 2) from the UE 550. The symbols generated by the transmit processor 520 are provided to a transmit frame processor 530 to create a frame structure. The transmit frame processor 530 creates this frame structure by multiplexing the symbols with a midamble 214 (FIG. 2) from the controller/processor 540, resulting in a series of frames. The frames are then provided to a transmitter 532, which provides various signal conditioning functions including amplifying, filtering, and modulating the frames onto a carrier for downlink transmission over the wireless medium through smart antennas 534. The smart antennas 534 may be implemented with beam steering bidirectional adaptive antenna arrays or other similar beam technologies.

At the UE 550, a receiver 554 receives the downlink transmission through an antenna 552 and processes the transmission to recover the information modulated onto the carrier. The information recovered by the receiver 554 is provided to a receive frame processor 560, which parses each frame, and provides the midamble 214 (FIG. 2) to a channel processor 594 and the data, control, and reference signals to a receive processor 570. The receive processor 570 then performs the inverse of the processing performed by the transmit processor 520 in the node B 510. More specifically, the receive processor 570 descrambles and despreads the symbols, and then determines the most likely signal constellation points transmitted by the node B 510 based on the modulation scheme. These soft decisions may be based on channel estimates computed by the channel processor 594. The soft decisions are then decoded and deinterleaved to recover the data, control, and reference signals. The CRC codes are then checked to determine whether the frames were successfully decoded. The data carried by the successfully decoded frames will then be provided to a data sink 572, which represents applications running in the UE 550 and/or various user interfaces (e.g., display). Control signals carried by successfully decoded frames will be provided to a controller/processor 590. When frames are unsuccessfully decoded by the receiver processor 570, the controller/processor 590 may also use an acknowledgement (ACK) and/or negative acknowledgement (NACK) protocol to support retransmission requests for those frames.

In the uplink, data from a data source 578 and control signals from the controller/processor 590 are provided to a transmit processor 580. The data source 578 may represent applications running in the UE 550 and various user interfaces (e.g., keyboard). Similar to the functionality described in connection with the downlink transmission by the node B 510, the transmit processor 580 provides various signal processing functions including CRC codes, coding and interleaving to facilitate FEC, mapping to signal constellations, spreading with OVSFs, and scrambling to produce a series of symbols. Channel estimates, derived by the channel processor 594 from a reference signal transmitted by the node B 510 or from feedback contained in the midamble transmitted by the node B 510, may be used to select the appropriate coding, modulation, spreading, and/or scrambling schemes. The symbols produced by the transmit processor 580 will be provided to a transmit frame processor 582 to create a frame structure. The transmit frame processor 582 creates this frame structure by multiplexing the symbols with a midamble 214 (FIG. 2) from the controller/processor 590, resulting in a series of frames. The frames are then provided to a transmitter 556, which provides various signal conditioning functions including amplification, filtering, and modulating the frames onto a carrier for uplink transmission over the wireless medium through the antenna 552.

The uplink transmission is processed at the node B 510 in a manner similar to that described in connection with the receiver function at the UE 550. A receiver 535 receives the uplink transmission through the antenna 534 and processes the transmission to recover the information modulated onto the carrier. The information recovered by the receiver 535 is provided to a receive frame processor 536, which parses each frame, and provides the midamble 214 (FIG. 2) to the channel processor 544 and the data, control, and reference signals to a receive processor 538. The receive processor 538 performs the inverse of the processing performed by the transmit processor 580 in the UE 550. The data and control signals carried by the successfully decoded frames may then be provided to a data sink 539 and the controller/processor, respectively. If some of the frames were unsuccessfully decoded by the receive processor, the controller/processor 540 may also use an acknowledgement (ACK) and/or negative acknowledgement (NACK) protocol to support retransmission requests for those frames.

The controller/processors 540 and 590 may be used to direct the operation at the node B 510 and the UE 550, respectively. For example, the controller/processors 540 and 590 may provide various functions including timing, peripheral interfaces, voltage regulation, power management, and other control functions. The computer readable media of memories 542 and 592 may store data and software for the node B 510 and the UE 550, respectively. A scheduler/processor 546 at the node B 510 may be used to allocate resources to the UEs and schedule downlink and/or uplink transmissions for the UEs.

Although not illustrated, one skilled in the art will comprehend that a UE 550 may include one or more additional transmit chains in addition to the transmit chain including blocks 580, 582, and 556; and one or more additional receive chains in addition to the receive chain including blocks 570, 560, and 554. That is, in a UE 550 configured to communicate on a plurality of cellular networks 302a, 302b, etc. (see FIG. 3), and/or to communicate with a wireless LAN 308, the UE may include a plurality of transmit and receive chains accordingly.

In one configuration according to the disclosure, the apparatus 100 (see FIG. 1) is a multimode device for wireless communication (e.g., UE) including means for obtaining an IMS registration by selecting among a plurality of domains based on one or more selection criteria. In addition, the apparatus 100 includes means for determining the availability of the plurality of domains according to RF characteristics corresponding to those domains, and means for determining a quality of service (QoS) of the plurality of domains, in order to determine whether an IMS application may utilize the IMS service it has requested. The aforementioned means is the processing system 114 configured to perform the functions recited by the aforementioned means. As described below, the processing system 114 includes the TX Processor 568 and the RX Processor 556. As such, in one configuration, the aforementioned means may be the TX Processor 568 and the RX Processor 556 configured to perform the functions recited by the aforementioned means.

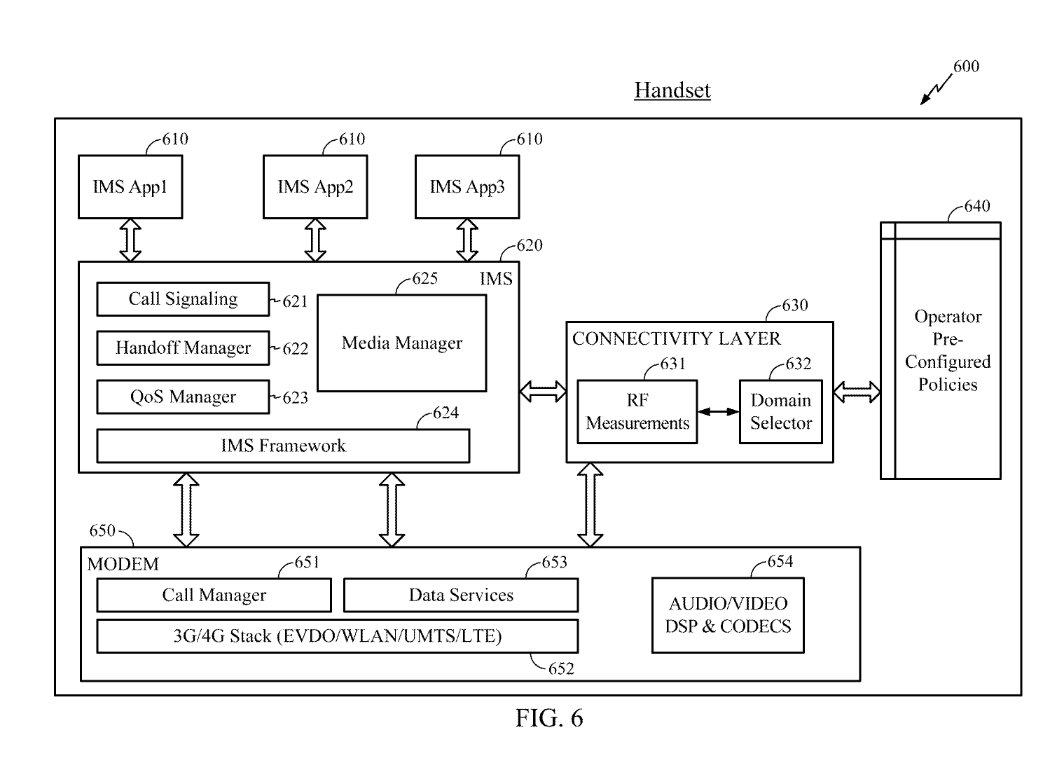

FIG. 6 is a conceptual block diagram illustrating certain modules within a UE. In an aspect of the disclosure, the modules shown in FIG. 6 are implemented in the processing system 100 illustrated in FIG. 1. For example, the processor 104, which interfaces with the computer-readable medium 106 through the bus 102, may include code or modules as illustrated in FIG. 6. That is, some of the blocks illustrated in FIG. 6 may be software modules; some may be combinations of software and hardware; and some may be hardware modules.

In an aspect of the disclosure, system 600 includes one or more IMS applications 610, an IMS stack 620, a connectivity layer 630, a memory 640, and a modem 650. The system 600 may be implemented as software between the IMS stack and the modem functionality, and may provide for the automatic change (e.g., an upgrade or downgrade) of an IMS service based on factors such as QoS and domain availability, as follows.

IMS Applications 610 represent respective multimedia applications such as VoIP applications, video conferencing applications, instant messaging applications, etc., residing within the UE. Each of the IMS applications 610 may receive information from and send information to (i.e., be communicatively coupled with) the IMS stack 620. Further, the IMS applications 610 may request certain IMS services from an IMS core in the network (not illustrated). For example, the IMS core may include various subsystems residing at upper layers, including the application and transport layers. IMS services may include such services as image sharing, multimedia telephony, instant messaging, video sharing, voice over IP (VoIP), push-to-talk, etc.

IMS stack 620 may be a module for providing IMS functionality to the UE. Here, IMS stack 620 includes a call signaling module 621, a handoff manager 622, a QoS manager 623, an IMS framework 624, and a media manager 625.

In an aspect of the disclosure, the call signaling module 621 provides the signaling utilized to initiate and/or establish a call on one or more domains. The handoff manager 622 may manage substantially seamless handoffs between different domains. For example, assume that a particular UE is running an IMS application such as a VoIP call at home over the user's wireless LAN. Based on a given criteria, the handoff manager 622 may initiate a handoff procedure to hand the call off to a cellular domain, enabling the VoIP call to continue without the user being interrupted. The particulars related to the signaling utilized during such a handoff from a packet-switched network to a circuit-switched network, or vice-versa, are standardized by both 3GPP and 3GPP2, and are generally referred to in the art as voice call continuity, or more generally, under 3GPP, IMS service continuity. Detailed information regarding IMS service continuity and voice call continuity can be found in 3GPP document number TS 23.237 v10.0.0, and in 3GPP2 document number X.S0048-0, respectively, each of which is incorporated by reference herein.

The IMS stack 620 may include a media manager 625 to enable communication between the IMS applications and the DSP engine and codecs. That is, the media manager 625 generally performs the functions of interfacing with an audio/video DSP & codecs in the modem 650, relieving the IMS applications 610 from being concerned with which APIs are being utilized by the DSP and codecs.

IMS Framework 624 may provide support for the underlying IMS stack utilizing RTP and RTCP protocols, based on IMS standards and SIP/RTP/RTCP RFCs.

In an aspect of the disclosure, QoS manager 623 provides quality of service (QoS) information to other blocks, such as the handoff manager 622 and/or the connectivity layer 630, to assist with an automatic change (e.g., an upgrade or a downgrade) in IMS service based on QoS. That is, various IMS applications 610 will each generally request an IMS service having a suitable QoS to improve their use of available bandwidth, and to provide an agreeable user experience. For example, if the access terminal is engaged in a VoIP call over a wireless LAN domain at a user's home, and another user begins streaming a large movie on the wireless LAN utilizing a laptop computer, the VoIP call may suffer. Thus, to reserve a certain amount of bandwidth for the VoIP call, an access terminal may request a certain QoS, to ensure the requested quality of service for the duration of the call. The QoS manager 623 may monitor the available QoS from one or more IMS services on one or on a plurality of available domains, and when the requested QoS is unavailable, the QoS manager 623 may provide an indication to other blocks to take appropriate action.

In another example, an access terminal may utilize an IMS application 610 that provides an IMS video sharing service, for example, a videoconferencing application or a streaming movie player, etc. IMS services that provide video generally require a much higher QoS than IMS services limited to audio data, such as VoIP, because the streaming video generally requires more bandwidth than audio data. In a scenario where the bandwidth required for the video service is unavailable, the QoS manager 623 may provide an indication that the requested QoS is unavailable from the network. In this case, the indication from the QoS manager 623 may include a request for the IMS application 610 to downgrade to an audio-only IMS service. In some aspects of the disclosure, the user may experience a notification indicating that the IMS application 610 will be downgraded from video to audio only service. In other aspects, the carrier may choose not to notify the user, and to downgrade the IMS service without the user's interaction. In various aspects of the disclosure, when the requested QoS becomes available, the QoS manager may provide an indication that the IMS service may be automatically upgraded to include video service.

As discussed above, in some aspects the QoS manager 623 may monitor the available QoS on a plurality of domains. Thus, when a requested QoS is unavailable on the current domain on which the access terminal is camped, the QoS manager may look for another domain in which the requested QoS is available. If a domain having the requested QoS is found to be available, the QoS manager 623 may provide an indication to the handoff manager 622 to trigger a handoff to the other domain, such that the IMS application 610 may utilize the other domain and have its requested QoS. In an aspect of the disclosure, the QoS manager may prioritize the actions. For example, when the requested QoS is unavailable on the domain on which the access terminal is camped, the QoS manager 623 may first look for an alternate domain having the requested QoS available. If it is available, a handoff to the other domain may be triggered. Otherwise, the QoS manager 623 may settle for initiating a downgrade to an IMS service that does not require as high a QoS.

The modem 650 generally includes an analog front end (e.g., the transmitter 556, the receiver 554, and the antenna 552 illustrated in FIG. 5) to provide an interface between analog and digital. In an aspect of the disclosure, the modem 650 may be implemented by all or a portion of receive frame processor 560, receive processor 570, transmit frame processor 582, and transmit processor 580 of FIG. 5. Referring again to FIG. 6, the modem 650 includes a call manager 651, a 3G/4G stack 652, data services 653, and audio/video DSP & codecs 654.

The audio and video DSP & codecs 654 may be implemented in a DSP, providing processing, coding, and decoding of audio and/or video data.

Call manager 651 may control the making and tearing down of calls, and various management of call activities. Call manager 651 may further provide support for multi-mode capabilities of the UE. The data services module 653 may be provided to communicate with a sockets layer for TCP/IP, UDP, to set up QoS, etc. For example, to begin a basic data services call, e.g., to transfer data from one mobile device to another, the data services module 653 may set up a PPP connection, retrieve an IP address from the PDSN, and once a link is established, transfer data between the mobile devices.

The call manager 651 and the data services module 653 may be implemented in software and executed by a microprocessor. From a system standpoint, the call manager 651 and the data services module 653 may be stationed above the MAC layer.

The 3G/4G stack 652 generally includes various hardware and/or software for implementing protocol-specific procedures for a number of domains, e.g., EVDO, WLAN, UMTS, LTE, or any of numerous other domains. In an aspect of the disclosure, the 3G/4G stack may be executed by a microprocessor, or in some embodiments, in a combination of a DSP and a microprocessor.

In an aspect of the disclosure, the connectivity layer 630 includes software modules that utilize various RF blocks that reside in the access terminal for any of a number of uses and functions. For example, the connectivity layer 630 may include an RF measurement module 631 that utilizes RF measurement blocks within the modem 650 to gather RF signal information, such as signal strength (e.g., for wireless LAN, a received signal strength indication (RSSI)), signal to noise ratio, signal to interference ratio, etc. Further, the connectivity layer may include a domain selector 632 for selecting among available domains, as described below.

In a further aspect of the disclosure, for a multimode device that may camp on various domains, the RF measurement module 631 gathers RF measurement information on each air interface corresponding to the various domains, and stores this information for later decision-making as to which air interface is capable of providing the best service at that moment. For example, the RF measurement module 631 may perform continuous monitoring of RF characteristics of the air interfaces, it may periodically query the RF circuitry for RF measurement information, or it may intermittently query the RF circuitry for RF measurement information based on other conditions.

In one example, if a user of an access terminal is at their home, they may be in a location where cellular coverage is very poor. However, at this location, the user may have a wireless LAN where coverage may be very good. In this instance, the RF measurement block 631 may indicate that the RSSI from the wireless LAN is very good, while the signal to interference ratio (e.g., E_{c}/I₀) of the cellular network is very poor. Thus, for a set of IMS applications 610 that are capable of utilizing the wireless LAN (perhaps in addition to the cellular network), the domain selector 632 may select the wireless LAN domain for IMS registration.

That is, the domain selector 632 receives information from the RF measurements block 631, among other blocks as described below, and utilizes an algorithm to select a suitable domain for the device to provide the services requested by the user, and which IMS applications 610 are capable of being run on this particular domain.

In addition to the RF measurement information from the RF measurements block 631, the selection of the domain by the domain selector 632 may depend on the QoS determined by the QoS manager 623 and input originating from one or more IMS applications 610. That is, the selection of a particular domain may depend on which domains are being demanded by the various IMS applications 610. Further, the domain selector 630 may look to other parameters to determine its choice of a particular domain, including such factors as the power consumption of a particular domain, etc.

In various aspects of the disclosure, the selection of a particular domain may occur continuously, periodically, or intermittently. In one aspect, domain re-selection occurs periodically with a relatively short period, in order to account for rapid changes in QoS, RF signal information, and demands from the various IMS applications 610. If no IMS applications 610 are being run at a particular time, then the domain selector may cease operation.

Memory 640 may be configured to include certain operator pre-configured policies. That is, the memory 640 may be a non-volatile memory module that statically stores information provided by the service provider. For example, the operator pre-configured policies may include a list of available radio interfaces or domains which the access terminal may access, and may further include a priority assignment corresponding to IMS applications and their corresponding domains. Further, the operator pre-configured policies may further include one or more fall-back domains that may be made available if the first choice of domain for an IMS application has too poor signal strength according to the latest RF measurements from the RF measurement block 631, too poor QoS according to the QoS manager 623, and/or other criteria.

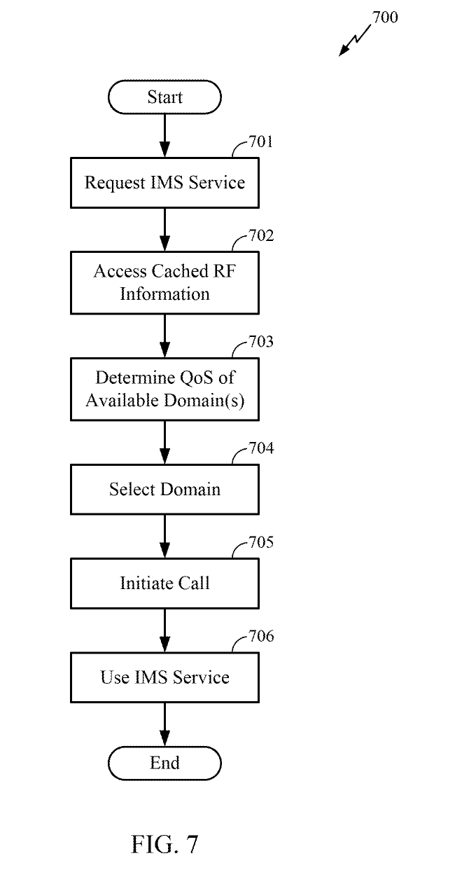

FIG. 7 is a flow chart 700 of a process of initiating a new call according to an aspect of the disclosure. In some aspects, a call may be initiated when a user launches an IMS application 610, as illustrated in FIG. 6, such as initiating a VoIP call, requesting a streaming movie, or initiating a push-to-talk session, among others. In block 701, the process requests an IMS service from the IMS core in the network. In general, the IMS application 610 requests a preferred IMS service, such as multimedia telephony, peer-to-peer video sharing, push-to-talk, etc., as appropriate, as well as a certain QoS, and the IMS stack 620 provides the request for IMS service to the IMS core in the network.

In block 702, the process accesses cached RF measurement information. That is, a typical UE may continuously or periodically measure RF characteristics of air interfaces and store or cache these RF characteristics for utilization by various modules included in the UE. For example, a multimode UE may continuously or periodically determine an E_{c}/I₀ value for a UMTS network and for a CDMA2000 network, as well as determine an RSSI value for a WLAN, and store or cache these values, which the process according to an aspect of the disclosure accesses for determination of a domain, as follows.

In block 703, the process determines the QoS of available domain(s). That is, the QoS manager 623 may determine the QoS of each domain whose air interface has an RF characteristic greater than a certain threshold, as determined in block 702. In some aspects of the disclosure, the determination of QoS may be independent of the RF measurements determined in block 702.

In block 704, the process selects a domain based on certain selection criteria including at least one of the RF measurements determined in block 702, the QoS of available domain(s) as determined in block 703, operator pre-configured policies stored in a memory 640, or possibly other factors such as a relative power consumption of available domain(s). For example, the operator pre-configured policies may include restrictions on certain domains based on the individual user's subscription, such as making a domain completely unavailable for use, or unavailable for usage with a certain IMS service or IMS application 610. Further, the pre-configured policies may place geographic restrictions such that certain domains are only available in the user's home network, or in other areas. Even further, the pre-configured policies may assign a priority to different domains, for example, placing a domain managed by the cellular operator at the highest priority, and assigning other domains, for example, cellular networks managed by other operators, at lower priorities. Those skilled in the art will comprehend that any number of policies relating to the selection of a particular domain may be configured in memory 640 within the spirit and scope of the instant disclosure and the claims appended hereto.

As noted above, the selection in block 704 of a particular domain may depend on additional factors, such as the RF measurement information determined in block 702. For example, in an aspect of the disclosure, if the RF measurement information corresponding to an air interface for a particular domain is below a threshold, that domain may not be selected. Similarly, the selection in block 704 of a particular domain may depend on the QoS determined in block 703. For example, in an aspect of the disclosure, if the QoS for a particular domain is below a threshold, that domain may not be selected.

In a further aspect of the disclosure, if none of the available domains has a QoS above the threshold (e.g., the threshold being the QoS requested by the IMS application 610 when it initiated a call), a domain may be selected having a lower QoS than requested. Here, the IMS application 610 may be notified that the QoS it requested is unavailable, and a compromise or downgrade in the IMS service may be achieved. For example, if the IMS application 610 were a video conference application that requested a high QoS, but QoS sufficient only for a voice call is available, the system may provide a downgraded IMS service that only enables voice, thus providing the user with the capability to establish a voice call, rather than simply denying the call.

In block 705, the process initiates the call utilizing the domain selected in block 704. That is, as described above, the call signaling block 621 initiates the call by instructing the modem 650 to utilize appropriate signaling to access the selected domain. In block 706, the media manager 625 utilizes the IMS framework 624 to manage the IMS service between the IMS application 610 and the modem 650, thus providing the user with the communication initially requested by the IMS application 610.

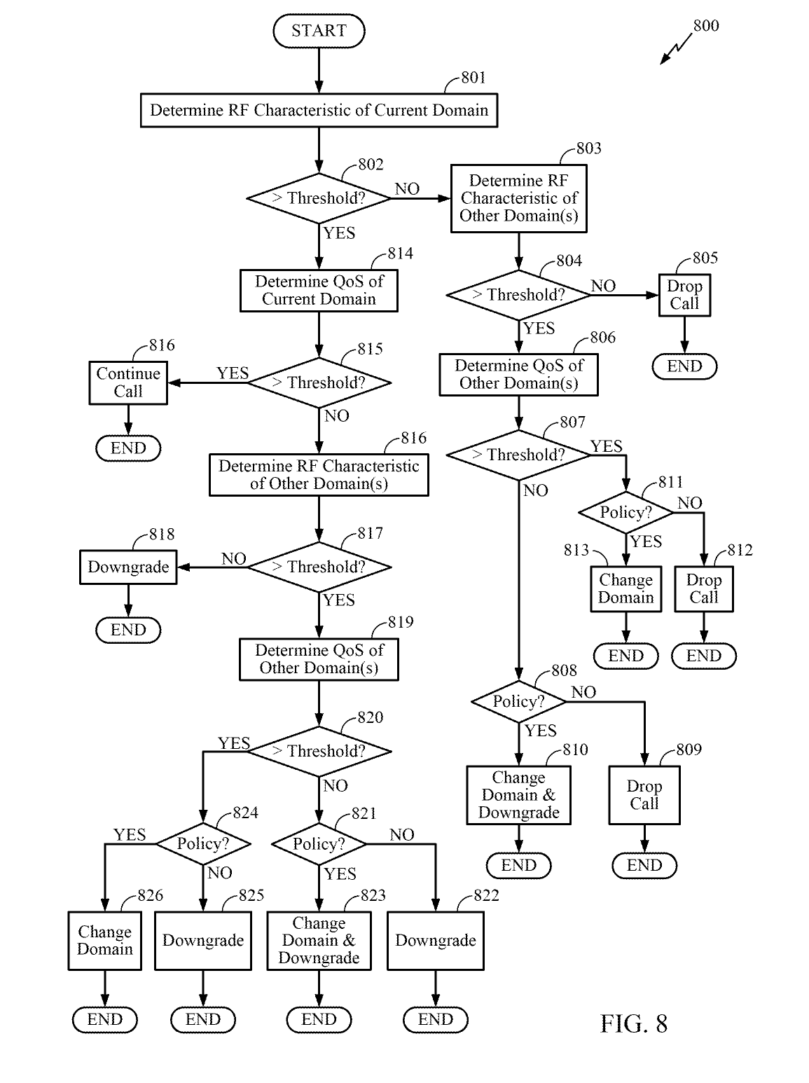

FIG. 8 is a flow chart illustrating a process 800 of monitoring and maintaining an ongoing IMS communication session on one or more domains. That is, an IMS application typically obtains an IMS registration at an initiation of an IMS communication session, such as a voice call or a video conference. However, according to an aspect of the disclosure, during the IMS communications session, changes in the air interface and/or changes in the available QoS for the domain being utilized may prompt a change (e.g., upgrade or downgrade) in IMS service, a change in domain, or both, possibly depending further on operator pre-configured policies and other factors. In an aspect of the disclosure, the process 800 may be executed by any suitable processing system in a multimode UE. In another aspect of the disclosure, the process 800 may be executed by the system 600 illustrated in FIG. 6, wherein the domain selector 632 generally compares RF measurements and QoS determinations with respective thresholds, queries memory 640 to determine the operator pre-configured policies, and requests the change of a domain and/or the change in IMS service, as follows.

At the start of the process 800, an IMS communication session such as a video conference, for example, is ongoing on a current domain, e.g., a WCDMA cellular network, utilizing a multimode UE. In block 801, the process determines an RF characteristic of the current domain. For example, the multimode UE may continuously or periodically determine a signal-to-interference ratio (E_{c}/I₀) of the WCDMA air interface and store a value corresponding to E_{c}/I₀ in a local cache. In this scenario, determining the RF characteristic may include reading this cached value. In some aspects of the disclosure, other process steps may be utilized to determine the RF characteristic, such as triggering a measurement of the RF characteristic.

In block 802, the process determines whether the RF characteristic determined in block 801 is greater than a threshold. If the RF characteristic is not greater than the threshold, then the IMS communication session may be at risk of being lost with a dropped call. Thus, in block 803, the process determines an RF characteristic of one or more other domains. Here, the multimode UE may continuously or periodically determine an RF characteristic such as E_{c}/I₀, RSSI, a signal-to-noise ratio, or any other suitable RF characteristic of the air interface(s) other than that of the domain currently being utilized for the IMS communication session. Further, the UE may store the RF characteristic(s) determined in a local cache. In this scenario, determining the RF characteristic of the other domain(s) may include reading these cached values. In some aspects of the disclosure, other process steps may be utilized to determine the RF characteristic(s), such as triggering a measurement of the RF characteristic(s).

In block 804, the process determines whether the RF characteristics of the other domains are greater than respective thresholds. If none of the other domains have RF characteristics greater than the respective thresholds, then in block 805, the process may drop the call because no available domain is capable of maintaining the IMS communication session. However, if at least one of the other domains has an RF characteristic greater than the respective threshold, in block 806, the process determines the QoS of the other domain(s) having the RF characteristic greater than the respective threshold. In some aspects, the determining of the QoS of the other domains may be initiated in block 806, such that the QoS manager (see FIG. 6) queries the appropriate domain or domains to determine their respective QoS. In block 807, the process determines whether the QoS of the respective domains is greater than a threshold. Here, the threshold may be a QoS specifically requested by an IMS application utilizing the current IMS communication session, or the threshold may be set to any other suitable value. If none of the respective domains has a QoS greater than the respective threshold, then in block 808 the process queries operator pre-configured policies to determine whether any of the other domains, which has a QoS less than the respective threshold, the UE may utilize, and in which priority. If the policies indicate that none of the respective domains should be utilized, then in block 809 the process drops the call, thus terminating the IMS communication session. On the other hand, if at least one of the domains under the current conditions falls within the operator pre-configured policies despite having a QoS less than the respective threshold, then in block 810 the process executes a handoff to change to that domain, and the IMS service is downgraded to a service that may utilize the lower QoS. Here, the IMS application in the UE utilizing the IMS communication session may experience a loss of quality or even a loss of a high-bandwidth service such as video, however, the IMS communication session is maintained.

Returning to block 807, if the process determines that the QoS of at least one of the other domains is greater than the respective threshold, then in block 811 the process queries the operator pre-configured policies to determine whether any of the other domains, which has a QoS greater than the respective threshold, the UE may utilize, and in which priority. If the policies indicate that none of the respective domains should be utilized, then in block 812 the process drops the call, thus terminating the IMS communication session. On the other hand, if at least one of the domains under the current conditions falls within the operator pre-configured policies, then in block 813 the process executes a handover to change to that domain. In an aspect of the disclosure, if multiple domains have a suitable RF characteristic and QoS, then in block 813 the process further determines the priority of the respective domains as determined in the operator pre-configured policies.

Returning now to block 802, if the process determines that the RF characteristic of the current domain is greater than the threshold, then in block 814 the process determines the QoS of the current domain, as described above. In block 815, the process determines whether the QoS of the current domain is greater than a threshold, also as described above. If the QoS is greater than the threshold, then the ongoing IMS communication session is continued in block 816, because the RF signal and the available QoS have each been determined to be suitable for the session. However, if the QoS of the current domain is less than the threshold, then the ongoing IMS communication session is at risk of having communication issues, such as when the QoS is less than adequate to maintain a voice call or a streaming video conference. Thus, in block 816, the process determines an RF characteristic of one or more other domains, and in block 817, the process determines whether the RF characteristic of the one or more other domains is greater than a respective threshold. If none of the other domain(s) has an RF characteristic greater than the respective threshold, then in block 818, the process downgrades the IMS service utilized over the currently-used domain. For example, the IMS service may be downgraded from a multimedia telephony service including video and voice, to a voice-only service, or from an audio service to a text- or data-only service where the low QoS available may be adequate. If, however, the process determines in block 817 that at least one of the other domains has an RF characteristic greater than the respective threshold, then in block 819 the process determines a QoS of the other domain(s) having the suitable RF characteristics. In block 820, the process determines whether that QoS is greater than a threshold. If the answer is no, then none of the available domains has a QoS greater than the threshold(s), for example, a QoS requested by an IMS application. Thus, in block 821, the process determines which of the available domains (i.e., the domains having RF characteristics greater than respective threshold(s)) should be utilized by the IMS application according to policy (e.g., operator pre-configured policies stored in memory 640, see FIG. 6). As described above, the policies may include restrictions on certain domains or priorities to determine which domain to choose. If none of the domains other than the one currently being utilized has a higher priority or other reason to necessitate a handoff to another domain, then in block 822, the process downgrades the IMS service in the current domain. However, if the process determines in block 821 that according to policy a handoff to another domain should occur, then in block 823 a handoff to the other domain takes place and the IMS service is downgraded.

Returning to block 820, if the process determines that at least one of the other domains has a QoS greater than the threshold(s), then a handoff to that domain may be in order to maintain the IMS communication session at a high QoS. Thus, in block 824 the process determines whether any of the domains having suitable QoS (as determined in block 820) and suitable RF characteristics (as determined in block 816) should be utilized for a handoff according to policy (e.g., the operator pre-configured policies stored in memory 640, see FIG. 6). If none of the other domains should be utilized, according to the policy, then the process maintains the IMS communication session utilizing the existing domain and downgrades the IMS service in block 825. If, however, at least one of the other domains is within the policy, then in block 824 the process determines, according to priority or other rules stored in the policy, a suitable domain and in block 826 the process executes a handoff to that other domain. Thus, the IMS communication session is maintained in a different domain at a high QoS.

It is understood that the specific order or hierarchy of steps in the processes disclosed is an illustration of exemplary approaches. Based upon design preferences, it is understood that the specific order or hierarchy of steps in the processes may be rearranged. The accompanying method claims present elements of the various steps in a sample order, and are not meant to be limited to the specific order or hierarchy presented. For example, in an aspect of the disclosure, the policy (e.g., operator pre-configured policies stored in memory 640) may be considered prior to determining RF characteristics of other domains and/or prior to determining the QoS of the other domains. Those skilled in the art will comprehend that various other modifications may be made to the illustrated process, still within the scope of the instant disclosure.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication utilizing a multimode access terminal capable of obtaining an IP Multimedia Subsystem (IMS) registration through at least a first domain and a second domain, the method comprising:
selecting the first domain or the second domain for an IMS communication session in accordance with at least one selection criterion.

2. The method of claim 1, wherein the at least one selection criterion comprises information in a data structure stored in a memory on the multimode access terminal.

3. The method of claim 2, wherein the data structure is configured to represent a first priority for the first domain and a second priority for the second domain.

4. The method of claim 3, wherein the data structure is further configured to represent policies corresponding to obtaining the IMS registration with the first domain or the second domain.

5. The method of claim 4, wherein the policies are preconfigured policies determined by a service provider.

6. The method of claim 1, wherein the at least one selection criterion comprises an availability of the first domain and an availability of the second domain.

7. The method of claim 6, wherein the availability of one of the first domain or the second domain comprises a signal strength of an RF signal corresponding to the first domain or the second domain, respectively.

8. The method of claim 6, wherein the availability of one of the first domain or the second domain comprises a signal-to-interference ratio of an RF signal corresponding to the first domain or the second domain, respectively.

9. The method of claim 6, wherein the availability of one of the first domain or the second domain comprises a signal-to-noise ratio of an RF signal corresponding to the first domain or the second domain, respectively.

10. The method of claim 6, wherein the availability of the first and second domain corresponds to whether a characteristic of an RF signal corresponding to the first domain or the second domain, respectively, exceeds a threshold.

11. The method of claim 1, wherein the at least one selection criterion comprises a quality of service (QoS) corresponding to the first domain and a QoS corresponding to the second domain.

12. The method of claim 11, further comprising initiating the IMS communication session in the first domain, and wherein the selecting of the first domain or the second domain comprises selecting the first domain or the second domain during the IMS communication session.

13. The method of claim 12, further comprising maintaining the IMS communication session while downgrading an IMS service associated with the IMS communication session when a first QoS associated with the first domain is below a threshold.

14. The method of claim 13, further comprising maintaining the IMS communication session while upgrading the IMS service associated with the IMS communication session when the first QoS associated with the first domain exceeds the threshold.

15. An apparatus for wireless communication utilizing a multimode access terminal, the apparatus comprising:
means for obtaining an IP Multimedia Subsystem (IMS) registration through at least a first domain and a second domain; and
means for selecting the first domain or the second domain for an IMS communication session in accordance with at least one selection criterion.

16. The apparatus of claim 15, wherein the at least one selection criterion comprises information in a data structure stored in a memory on the multimode access terminal.

17. The apparatus of claim 16, wherein the data structure is configured to represent a first priority for the first domain and a second priority for the second domain.

18. The apparatus of claim 17, wherein the data structure is further configured to represent policies corresponding to obtaining the IMS registration with the first domain or the second domain.

19. The apparatus of claim 18, wherein the policies are preconfigured policies determined by a service provider.

20. The apparatus of claim 15, wherein the at least one selection criterion comprises an availability of the first domain and an availability of the second domain.

21. The apparatus of claim 20, wherein the availability of one of the first domain or the second domain comprises a signal strength of an RF signal corresponding to the first domain or the second domain, respectively.

22. The apparatus of claim 20, wherein the availability of one of the first domain or the second domain comprises a signal-to-interference ratio of an RF signal corresponding to the first domain or the second domain, respectively.

23. The apparatus of claim 20, wherein the availability of one of the first domain or the second domain comprises a signal-to-noise ratio of an RF signal corresponding to the first domain or the second domain, respectively.

24. The apparatus of claim 20, wherein the availability of the first and second domain corresponds to whether a characteristic of an RF signal corresponding to the first domain or the second domain, respectively, exceeds a threshold.

25. The apparatus of claim 15, wherein the at least one selection criterion comprises a quality of service (QoS) corresponding to the first domain and a QoS corresponding to the second domain.

26. The apparatus of claim 25, further comprising means for initiating the IMS communication session in the first domain, and wherein the means for selecting the first domain or the second domain comprises means for selecting the first domain or the second domain during the IMS communication session.

27. The apparatus of claim 26, further comprising means for maintaining the IMS communication session while downgrading an IMS service associated with the IMS communication session when a first QoS associated with the first domain is below a threshold.

28. The apparatus of claim 27, further comprising means for maintaining the IMS communication session while upgrading the IMS service associated with the IMS communication session when the first QoS associated with the first domain exceeds the threshold.

29. A computer program product for use in a multimode access terminal, the computer program product comprising:
a computer-readable medium comprising:
code for obtaining an IP Multimedia Subsystem (IMS) registration through at least a first domain and a second domain; and
code for selecting the first domain or the second domain for an IMS communication session in accordance with at least one selection criterion.

30. The computer program product of claim 29, wherein the at least one selection criterion comprises information in a data structure stored in a memory on the multimode access terminal.

31. The computer program product of claim 30, wherein the data structure is configured to represent a first priority for the first domain and a second priority for the second domain.

32. The computer program product of claim 31, wherein the data structure is further configured to represent policies corresponding to obtaining the IMS registration with the first domain or the second domain.

33. The computer program product of claim 32, wherein the policies are preconfigured policies determined by a service provider.

34. The computer program product of claim 29, wherein the at least one selection criterion comprises an availability of the first domain and an availability of the second domain.

35. The computer program product of claim 34, wherein the availability of one of the first domain or the second domain comprises a signal strength of an RF signal corresponding to the first domain or the second domain, respectively.

36. The computer program product of claim 34, wherein the availability of one of the first domain or the second domain comprises a signal-to-interference ratio of an RF signal corresponding to the first domain or the second domain, respectively.

37. The computer program product of claim 34, wherein the availability of one of the first domain or the second domain comprises a signal-to-noise ratio of an RF signal corresponding to the first domain or the second domain, respectively.

38. The computer program product of claim 34, wherein the availability of the first and second domain corresponds to whether a characteristic of an RF signal corresponding to the first domain or the second domain, respectively, exceeds a threshold.

39. The computer program product of claim 29, wherein the at least one selection criterion comprises a quality of service (QoS) corresponding to the first domain and a QoS corresponding to the second domain.

40. The computer program product of claim 39, further comprising code for initiating the IMS communication session in the first domain, and wherein the code for selecting the first domain or the second domain comprises code for selecting the first domain or the second domain during the IMS communication session.

41. The computer program product of claim 40, further comprising code for maintaining the IMS communication session while downgrading an IMS service associated with the IMS communication session when a first QoS associated with the first domain is below a threshold.

42. The computer program product of claim 41, further comprising code for maintaining the IMS communication session while upgrading the IMS service associated with the IMS communication session when the first QoS associated with the first domain exceeds the threshold.

43. An apparatus for wireless communication utilizing a multimode access terminal capable of obtaining an IP Multimedia Subsystem (IMS) registration through at least a first domain and a second domain, the apparatus comprising:
a processing system configured to select the first domain or the second domain for an IMS communication session in accordance with at least one selection criterion.

44. The apparatus of claim 43, wherein the at least one selection criterion comprises information in a data structure stored in a memory on the multimode access terminal.

45. The apparatus of claim 44, wherein the data structure is configured to represent a first priority for the first domain and a second priority for the second domain.

46. The apparatus of claim 45, wherein the data structure is further configured to represent policies corresponding to obtaining the IMS registration with the first domain or the second domain.

47. The apparatus of claim 46, wherein the policies are preconfigured policies determined by a service provider.

48. The apparatus of claim 43, wherein the at least one selection criterion comprises an availability of the first domain and an availability of the second domain.

49. The apparatus of claim 48, wherein the availability of one of the first domain or the second domain comprises a signal strength of an RF signal corresponding to the first domain or the second domain, respectively.

50. The apparatus of claim 48, wherein the availability of one of the first domain or the second domain comprises a signal-to-interference ratio of an RF signal corresponding to the first domain or the second domain, respectively.

51. The apparatus of claim 48, wherein the availability of one of the first domain or the second domain comprises a signal-to-noise ratio of an RF signal corresponding to the first domain or the second domain, respectively.

52. The apparatus of claim 48, wherein the availability of the first and second domain corresponds to whether a characteristic of an RF signal corresponding to the first domain or the second domain, respectively, exceeds a threshold.

53. The apparatus of claim 43, wherein the at least one selection criterion comprises a quality of service (QoS) corresponding to the first domain and a QoS corresponding to the second domain.

54. The apparatus of claim 53, further comprising initiating the IMS communication session in the first domain, and wherein the selecting of the first domain or the second domain comprises selecting the first domain or the second domain during the IMS communication session.

55. The apparatus of claim 54, further comprising maintaining the IMS communication session while downgrading an IMS service associated with the IMS communication session when a first QoS associated with the first domain is below a threshold.

56. The apparatus of claim 55, further comprising maintaining the IMS communication session while upgrading the IMS service associated with the IMS communication session when the first QoS associated with the first domain exceeds the threshold.

57. A processing system for use in a multimode access terminal capable of obtaining an IP Multimedia Subsystem (IMS) registration through at least a first domain and a second domain, the processing system comprising:
a memory module for storing domain policies;
an RF measurement module for retrieving RF signal information associated with the first domain and the second domain;
a QoS manager for retrieving QoS information associated with the first domain and the second domain; and
a domain selector for selecting one of the first domain or the second domain in response to the RF signal information, the QoS information, and the domain policies.
